(19) United States
(12) Patent Application Publication
(10) Pub. No.: US 2026/0304385 A1
(43) Pub. Date: Oct. 1, 2026

(54) RADIO LINK CONTROL (RLC) CONTROL PROTOCOL DATA UNIT (PDU) PROTECTION

(71) Applicant: QUALCOMM Incorporated, San Diego, CA (US)

(72) Inventors: Sherif ELAZZOUNI, San Diego, CA (US); Soo Bum LEE, San Diego, CA (US); Gavin Bernard HORN, La Jolla, CA (US)

(21) Appl. No.: 19/090,352

(22) Filed: Mar. 25, 2025

(51) Int. Cl. H04W 72/04

(52) U.S. Cl. CPC H04W 72/04

(57) ABSTRACT

An apparatus, method and computer-readable media are disclosed for securing communications for a wireless network. For example, a process for securing communications for a wireless network can include: generating, at a radio link control (RLC) layer, an RLC control protocol data unit (PDU), the RLC control PDU including RLC control information; ciphering, at the RLC layer based on an RLC key, the RLC control information of the RLC control PDU to generate a ciphered RLC control PDU, wherein the RLC key is derived based on a distributed unit key; and outputting the ciphered RLC control PDU.

### FIELD

The present disclosure generally relates to wireless communications. For example, aspects of the present disclosure relate to protecting radio link control (RLC) control protocol data units (PDUs) in a wireless network.

### BACKGROUND

Wireless communications systems are deployed to provide various telecommunications and data services, including telephony, video, data, messaging, and broadcasts. Broadband wireless communications systems have developed through various generations, including a first-generation analog wireless phone service (1G), a second-generation (2G) digital wireless phone service (including interim 2.5G networks), a third-generation (3G) high speed data, Internet-capable wireless device, and a fourth-generation (4G) service (e.g., Long-Term Evolution (LTE), WiMax). Examples of wireless communications systems include code division multiple access (CDMA) systems, time division multiple access (TDMA) systems, frequency division multiple access (FDMA) systems, orthogonal frequency division multiple access (OFDMA) systems, Global System for Mobile communication (GSM) systems, etc. Other wireless communications technologies include 802.11 Wi-Fi, Bluetooth, among others.

A fifth-generation (5G) mobile standard calls for higher data transfer speeds, greater number of connections, and better coverage, among other improvements. The 5G standard (also referred to as “New Radio” or “NR”), according to Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. A sixth-generation (6G) mobile standard may build on 5G to offer further increased data transfer speeds, better coverage, and improved security, among other improvements.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Disclosed are systems, methods, apparatuses, and computer-readable media for performing wireless communications. In one illustrative example, an apparatus for securing communications for a wireless network is presented. The apparatus includes a memory and a processor coupled to the memory and configured to: generate, at a radio link control (RLC) layer, an RLC control protocol data unit (PDU), the RLC control PDU including RLC control information; cipher, at the RLC layer based on an RLC key, the RLC control information of the RLC control PDU to generate a ciphered RLC control PDU, wherein the RLC key is derived based on a distributed unit key; and output the ciphered RLC control PDU.

As another example, a method for securing communications for a wireless network is provided. The method includes: generating, at a radio link control (RLC) layer, an RLC control protocol data unit (PDU), the RLC control PDU including RLC control information; ciphering, at the RLC layer based on an RLC key, the RLC control information of the RLC control PDU to generate a ciphered RLC control PDU, wherein the RLC key is derived based on a distributed unit key; and outputting the ciphered RLC control PDU.

In another example, a non-transitory computer-readable medium having stored thereon instructions is provided. The instructions, when executed by at least one processor, cause the at least one processor to: generate, at a radio link control (RLC) layer, an RLC control protocol data unit (PDU), the RLC control PDU including RLC control information; cipher, at the RLC layer based on an RLC key, the RLC control information of the RLC control PDU to generate a ciphered RLC control PDU, wherein the RLC key is derived based on a distributed unit key; and output the ciphered RLC control PDU.

As another example, an apparatus for securing communications for a wireless network is provided. The apparatus includes: means for generating, at a radio link control (RLC) layer, an RLC control protocol data unit (PDU), the RLC control PDU including RLC control information; means for ciphering, at the RLC layer based on an RLC key, the RLC control information of the RLC control PDU to generate a ciphered RLC control PDU, wherein the RLC key is derived based on a distributed unit key; and means for outputting the ciphered RLC control PDU.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description.

### BRIEF DESCRIPTION OF THE DRAWINGS

Examples of various implementations are described in detail below with reference to the following figures:

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment, in accordance with some examples;

FIG. 5 is a block diagram illustrating a portion of a user plane (UP) protocol stack for a wireless network, in accordance with aspects of the present disclosure;

FIG. 6 is a block diagram illustrating a protocol stack for packetization of data formats, in accordance with aspects of the present disclosure;

FIG. 7 illustrates RLC layer ciphering and deciphering, in accordance with aspects of the present disclosure;

FIG. 8 is an example protected RLC control PDU, in accordance with aspects of the present disclosure;

FIG. 9 is a is a tree diagram illustrating a key hierarchy for a wireless system, in accordance with aspects of the present disclosure;

FIG. 10 is a flow diagram illustrating a process for securing communications for a wireless network, in accordance with aspects of the present disclosure; and

FIG. 11 is a diagram illustrating an example of a system for implementing certain aspects of the present technology.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Wireless networks are deployed to provide various communication services, such as voice, video, packet data, messaging, broadcast, and the like. A wireless network may support both access links for communication between wireless devices. An access link may refer to any communication link between a client device (e.g., a user equipment (UE), a station (STA), or other client device) and a base station (e.g., a 3^{rd} Generation Partnership Project (3GPP) gNodeB (gNB) for 5G/NR, a 3GPP eNodeB (eNB) for LTE, a Wi-Fi access point (AP), or other base station) or a component of a disaggregated base station (e.g., a central unit, a distributed unit, and/or a radio unit). In one example, an access link between a UE and a 3GPP gNB may be over a Uu interface. In some cases, an access link may support uplink signaling, downlink signaling, connection procedures, etc.

Various systems and techniques are provided with respect to wireless technologies (e.g., The 3GPP 5G/New Radio (NR) Standard, 6G, etc.) to provide improvements to wireless communications. A device (e.g., a UE, wireless device, mobile device, etc.) can be configured to access a wireless network (e.g., wireless system) to communicate with other devices. As a part of accessing the wireless network, the device may be configured to authenticate with the wireless network. Based on the authentication, the device may establish one or more security contexts to allow for private communications between the device and services of the wireless network. In some wireless networks, a device connecting to the wireless network may establish a security context with a security function of a core network (e.g., non-access stratum (NAS) security). Based on this security context, additional application layer security may be established on top of this security context.

A radio link control (RLC) layer may be a protocol layer of a wireless protocol stack where the packetization of data for transmission, depacketization of received data, error correction, retransmission, and the like is performed. As used herein, operations performed by a protocol layer are intended to describe operations performed by a processor, other hardware, as instructed by software instructions of the protocol layer (e.g., operations at the layer). A wireless protocol stack may be a set of protocols structured in layers which define how wireless devices can communicate with each other. The RLC layer may be present in the wireless protocol stack of both wireless nodes and wireless devices. A wireless node, or network node, base station, etc., may be device through which access to a wireless network may be provided. A wireless device, or UE, may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. Examples of a wireless node may include an eNB, gNB, central unit (CU), distributed unit (DU), access point (AP), etc.

For wireless networks, the RLC layer may be hosted by DUs associated with a CU (e.g., centralized wireless node). The centralized wireless node may be a CU, where the CU may be a part of a disaggregated base station which provides support for higher layers of a wireless protocol stack. The DU may be another part of the disaggregated base station which provides support for lower layers of the wireless protocol stack, such as the RLC layer and MAC layer. The MAC layer may be a protocol layer of a wireless protocol stack which manages radio resources for communications between wireless nodes and wireless devices in some wireless communications networks.

In some cases, the RLC layer may generate control information and may package the control information in RLC control protocol data units (PDUs). The RLC layer may generate RLC control PDUs to carry RLC control information, such as status information for RLC PDUs at an RLC receiver indicating whether information has been received (e.g., acknowledgement or ACK) or not received (e.g., negative acknowledgement or NACK). In some cases, the RLC layer may not perform separate ciphering and/or integrity protection for PDUs as security protecting PDUs may be performed by other layers of the wireless protocol stack. Ciphering, also known as encryption, may transform plaintext to ciphertext (e.g., encrypted text) to protect the plaintext from being read by an attacker. Integrity protection may be a security feature which may verify received data to ensure that the data was not changed. This is problematic for RLC control PDUs as the RLC control PDUs may not be ciphered. It may be useful to cipher RLC control PDUs to help minimize potential information exposure and avoid potential fake base station attacks that may exploit RLC control PDUs.

Systems, apparatuses, processes (also referred to as methods), and computer-readable media (collectively referred to as “systems and techniques”) are described herein for securing communications for an RLC layer of a wireless network. For example, an RLC layer of a transmitter may generate RLC control information for transmission. The transmitter may be a wireless node or a wireless device. The RLC layer may generate an RLC control PDU including the RLC control information. The RLC layer may cipher the RLC control information to generate a ciphered RLC control PDU. The ciphering may be based, in part, on an RLC key. The RLC key may be a cryptographic key that may be used to secure RLC messages.

The ciphering may also be based on bearer information. Bearer information may be information related to a bearer associated with an RLC entity or connection that may be input to a key derivation formula to generate the RLC key. A bearer (e.g., data radio bearer (DRB)) may be a logical channel that may be used to transmit data between a wireless device and a wireless node. A bearer may be associated with multiple protocol sessions. For example, an RLC entity or instance may be configured for the bearer. The RLC entity may refer to a single logical RLC session and multiple RLC entities may exist concurrently and the RLC entities may be instantiated and controlled by the RLC layer. The key derivation formula may be a cryptographic algorithm that generates one or more keys based on one or more inputs. In some cases, the bearer information may be obtained based on information mapping a logical channel identifier (LCID) to a bearer identifier number. In some cases, the information mapping a LCID to a bearer number may be received from another wireless node, such as a CU. For example, for a disaggregated base station, the RLC layer may be anchored in the DU and the DU may use a logical channel ID (LCID) to distinguish between RLC sessions. However, the bearer may be anchored in the CU and the CU may have information indicating which LCID maps to which bearer identifier number and/or PDCP session. The CU may send the information indicating which LCID maps to which bearer identifier number and/or PDCP session to the DU. The LCID may be a field in the MAC message (e.g., MAC CE, MAC subPDU, etc.) that may be used to identify a logical channel (or type of MAC CE) associated with a subPDU of the MAC subPDUs. The bearer identifier number may be a unique number that identifies a specific bearer.

In some cases, the bearer information may be based on virtual bearer information. The virtual bearer information may be based on bearer information modified for subsequent processing and used in place of bearer information. The virtual bearer information may be constructed based on the bearer identifier number. For example, the virtual bearer information may be based on a concatenation of the bearer identifier number and a digit. In some cases, the digit may be a data/control bit. The data/control bit may be a bit included in a header of an RLC PDU indicating whether the RLC PDU is an RLC data PDU or an RLC control PDU. A header may be a portion of a packet, such as a PDU, that contains information about contents of the packet and the header may be located at a beginning of the packet.

In some cases, the bearer information may be based on a virtual LCID. The virtual LCID may be constructed based on the LCID. For example, the virtual LCID may be based on a concatenation of the LCID and a digit. In some cases, the digit may be a data/control bit.

The ciphering may also be based on a count number of the RLC control PDU. The count number may be a sequentially increasing number that is included in the header of the RLC control PDU. In some cases, the count number may be specific to the RLC control PDU such that each RLC control PDU is allocated a count number that is sequentially larger than the count number allocated to a previous RLC control PDU. In some cases, the count number may be shared between the RLC control PDUs and RLC data PDUs. For example, an RLC data PDU may include a first count number, and a following RLC data PDU may include a second count number that is sequentially larger than the first count number.

In some cases, the CU may configure the DU to perform RLC control PDU protection based on DU security capabilities. For example, when a DU is connected to a CU (e.g., as a part of a setup procedure), the DU may transmit an indication of the DU's security capabilities to the CU. This transmission may be via intra-cell signaling, such as via, for example, the F1 interface in a 5G network. For example, the DU may indicate that the DU supports RLC control PDU protection. In response, the CU may configure the DU to perform RLC control PDU protection based on this indication. For example, the DU may receive an indication to protect RLC control PDUs (e.g., to perform RLC control PDU protection) and the DU may cipher RLC control information for RLC control PDUs based on the received indication to protect RLC control PDUs.

The ciphered RLC control PDU may be an RLC control PDU with a ciphered payload. The ciphered RLC control PDU may be output. For example, the ciphered RLC control PDU may be output to a lower layer, such as the MAC layer. The MAC layer may packetize the ciphered RLC control PDU into MAC protocol data units (PDU) for transmission to a receiver. A data packet (may be a unit of information that may be sent from a transmitter, such as a first layer or first device, to a receiver, such as a second layer or second device.

In some cases, the RLC layer of a receiver may receive a ciphered RLC control PDU. The receiver may be a wireless node or a wireless device. The RLC layer of the receiver may decipher the received ciphered RLC control PDU based on a count number in a header of the ciphered RLC control PDU. The RLC layer may further decipher the received ciphered RLC control PDU based on at least one of a logical channel identifier (LCID), bearer information, a virtual LCID, or virtual bearer identifier.

Additional aspects of the present disclosure are described in more detail below.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs may communicate with a core network via a RAN, and through the core network the UEs may be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

A network entity may be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several radio access technologies (RATs) in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs may send signals to a base station is called an uplink (UL) channel (e.g., a reverse traffic channel, a reverse control channel, an access channel, etc.). A communication link through which the base station may send signals to UEs is called a downlink (DL) or forward link channel (e.g., a paging channel, a control channel, a broadcast channel, or a forward traffic channel, etc.). The term traffic channel (TCH), as used herein, may refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

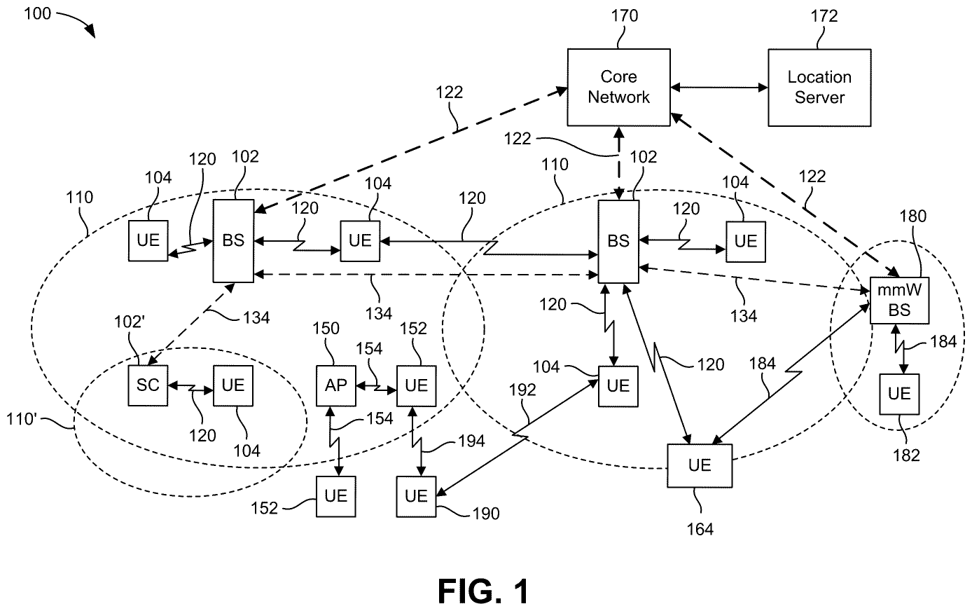

Various aspects of the systems and techniques described herein will be discussed below with respect to the figures. According to various aspects, FIG. 1 illustrates an example of a wireless communications system 100. The wireless communications system 100 (which may also be referred to as a wireless wide area network (WWAN)) may include various base stations 102 and various UEs 104. In some aspects, the base stations 102 may also be referred to as “network entities” or “network nodes.” One or more of the base stations 102 may be implemented in an aggregated or monolithic base station architecture. Additionally, or alternatively, one or more of the base stations 102 may be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 may include macro cell base stations (high power cellular base stations) and/or small cell base stations (low power cellular base stations). In an aspect, the macro cell base station may include eNBs and/or ng-eNBs where the wireless communications system 100 corresponds to a long term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency may be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 may include devices (e.g., UEs, etc.) that communicate with one or more UEs 104, base stations 102, APs 150, etc. utilizing the ultra-wideband (UWB) spectrum. The UWB spectrum may range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (from 450 to 6000 Megahertz (MHz)), FR2 (from 24250 to 52600 MHz), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like may be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In order to operate on multiple carrier frequencies, a base station 102 and/or a UE 104 may be equipped with multiple receivers and/or transmitters. For example, a UE 104 may have two receivers, “Receiver 1” and “Receiver 2,” where “Receiver 1” is a multi-band receiver that may be tuned to band (i.e., carrier frequency) ‘X’ or band ‘Y,’ and “Receiver 2” is a one-band receiver tuneable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 104 is being served in band ‘X’ or band ‘Y,’ because of the separate “Receiver 2,” the UE 104 may measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

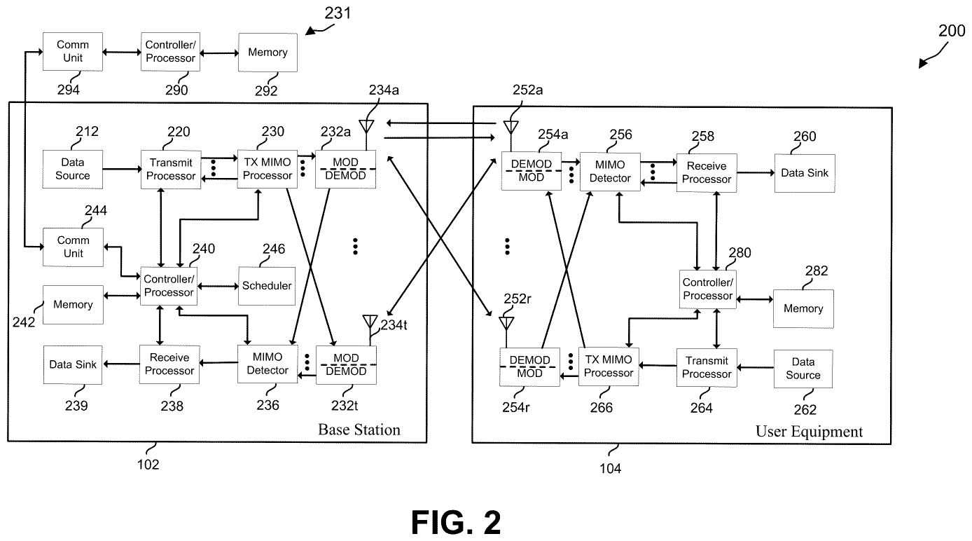

FIG. 2 shows a block diagram of a design of a base station 102 and a UE 104 that enable transmission and processing of signals exchanged between the UE and the base station, in accordance with some aspects of the present disclosure. Design 200 includes components of a base station 102 and a UE 104, which may be one of the base stations 102 and one of the UEs 104 in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, channel state information, channel state feedback, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators may be separate components. Each modulator of the modulators 232a to 232t may process a respective output symbol stream, e.g., for an orthogonal frequency-division multiplexing (OFDM) scheme and/or the like, to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals may be generated with location encoding to convey additional information.

At UE 104, antennas 252a through 252r may receive the downlink signals from base station 102 and/or other base stations and may provide received signals to demodulators (DEMODs) 254a through 254r, respectively. The demodulators 254a through 254r are shown as a combined modulator-demodulator (MOD-DEMOD). In some cases, the modulators and demodulators may be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, channel state information, channel state feedback, and/or the like) from controller/processor 280. Transmit processor 264 may also generate reference symbols for one or more reference signals (e.g., based at least in part on a beta value or a set of beta values associated with the one or more reference signals). The symbols from transmit processor 264 may be precoded by a TX-MIMO processor 266 if application, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 if applicable, and further processed by a receive processor 238 to obtain decoded data and control information sent by UE 104. Receive processor 238 may provide the decoded data to a data sink 239 and the decoded control information to controller (processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit uplink control information (UCI) beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), wireless node, or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU (e.g., centralized wireless node) may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

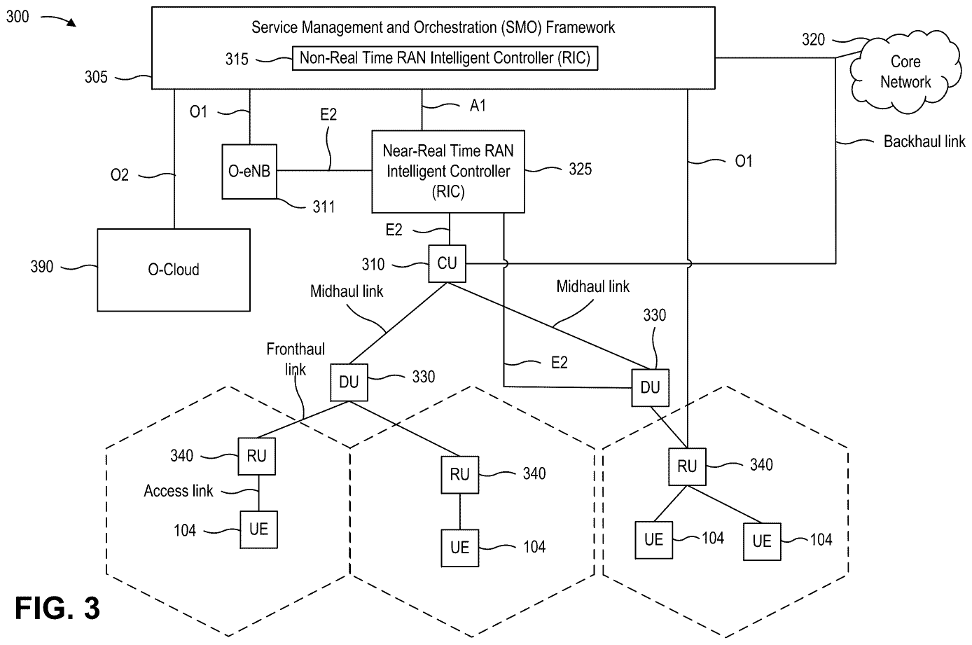

FIG. 3 shows a diagram illustrating an example disaggregated base station 300 architecture. The disaggregated base station 300 architecture may include one or more central units (CUs) 310 that may communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUS) 340 via respective fronthaul links. The RUs 340 may communicate with respective UEs 104 via one or more radio frequency (RF) access links. In some implementations, the UE 104 may be simultaneously served by multiple RUs 340.

Each of the units, e.g., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 may be logically split into one or more CU-UP units and one or more CU-CP units. The CU-UP unit may communicate bidirectionally with the CU-CP unit via an interface, such as the E1 interface when implemented in an O-RAN configuration. The CU 310 may be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) may be implemented with an interface configured to communicate signals with other layers (and modules) hosted by the DU 330, or with the control functions hosted by the CU 310.

Lower-layer functionality may be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 may be implemented to handle over the air (OTA) communication with one or more UEs 104. In some implementations, real-time and non-real-time aspects of control and user plane communication with the RU(s) 340 may be controlled by the corresponding DU 330. In some scenarios, this configuration may enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements may include, but are not limited to, CUs 310, DUs 330, RUs 340 and Near-RT RICs 325. In some implementations, the SMO Framework 305 may communicate with a hardware aspect of a 4G RAN, such as an open eNB (O-eNB) 311, via an O1 interface. Additionally, in some implementations, the SMO Framework 305 may communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

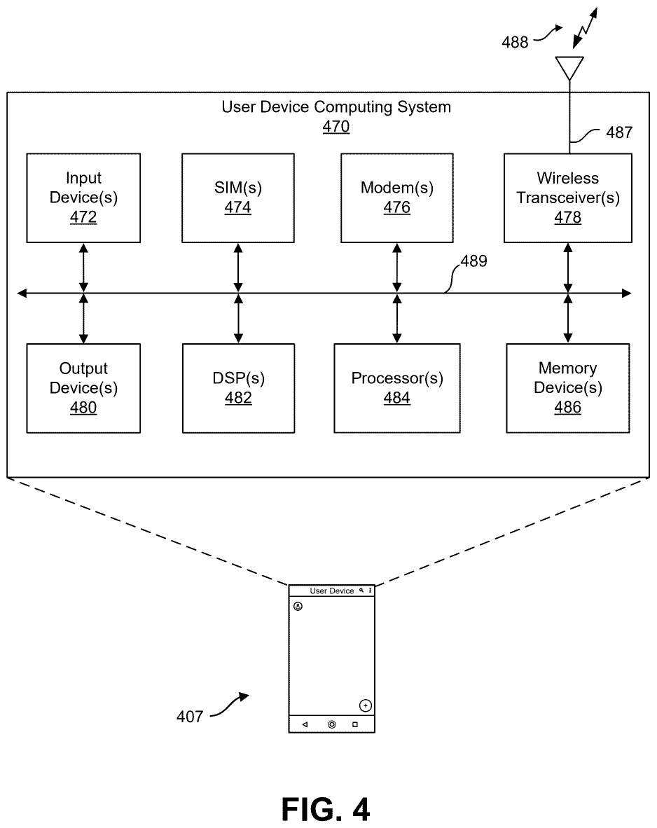

FIG. 4 illustrates an example of a computing system 470 of a wireless device 407. The wireless device 407 may include a client device such as a UE (e.g., UE 104, UE 152, UE 190) or other type of device (e.g., a station (STA) configured to communication using a Wi-Fi interface) that may be used by an end-user. For example, the wireless device 407 may include a mobile phone, router, tablet computer, laptop computer, tracking device, wearable device (e.g., a smart watch, glasses, an extended reality (XR) device such as a virtual reality (VR), augmented reality (AR) or mixed reality (MR) device, etc.), Internet of Things (IoT) device, access point, and/or another device that is configured to communicate over a wireless communications network. The computing system 470 includes software and hardware components that may be electrically or communicatively coupled via a bus 489 (or may otherwise be in communication, as appropriate). For example, the computing system 470 includes one or more processors 484. The one or more processors 484 may include one or more CPUs, ASICs, FPGAs, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The computing system 470 may also include one or more memory devices 486, one or more digital signal processors (DSPs) 482, one or more subscriber identity modules (SIMs) 474, one or more modems 476, one or more wireless transceivers 478, one or more antennas 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, computing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the computing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the computing system 470 may include a coding-decoding device (or CODEC) configured to encode and/or decode data transmitted and/or received using the one or more wireless transceivers 478. In some cases, the computing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The computing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable and/or the like. Such storage devices may be configured to implement any appropriate data storage, including without limitation, various file systems, database structures, and/or the like.

In various embodiments, functions may be stored as one or more computer-program products (e.g., instructions or code) in memory device(s) 486 and executed by the one or more processor(s) 484 and/or the one or more DSPs 482. The computing system 470 may also include software elements (e.g., located within the one or more memory devices 486), including, for example, an operating system, device drivers, executable libraries, and/or other code, such as one or more application programs, which may comprise computer programs implementing the functions provided by various embodiments, and/or may be designed to implement methods and/or configure systems, as described herein.

As indicated above, a DU may host a MAC layer. The MAC layer may be a protocol layer which manages radio resources for communications between wireless nodes and wireless devices in some wireless networks. For example, the MAC layer may serve to map between logical channels and transport channels, determine resource allocations, such as time/frequence resources, transmission scheduling, and the like. The MAC layer may also include signaling using MAC protocol data units (PDU) The MAC PDU may be a message format for MAC message (e.g., messages of the MAC layer).

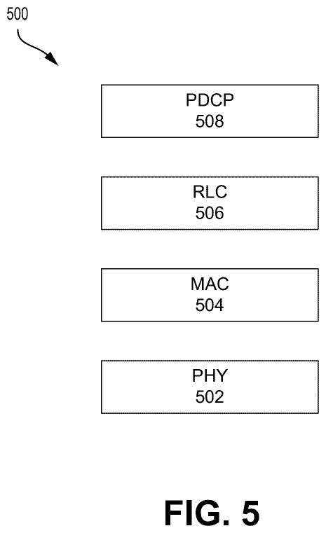

FIG. 5 is a block diagram illustrating a portion of a UP protocol stack 500 for a wireless network, in accordance with aspects of the present disclosure. As indicated above, a wireless network may include a network protocol stack including multiple layers which may perform different operations. In FIG. 5, the UP protocol stack 500 may include a physical (PHY) layer 502, a media access control (MAC) layer 504, a radio link control (RLC) layer 506, and a packet data convergence protocol (PDCP) layer 508. In some cases, the protocol stack 500 may be shared by a wireless node (e.g., eNB, gNB, CU, DU, AP, etc.) as well as by a wireless device (e.g., UE, mobile device, etc.). The PHY layer 502 may be a low-level layer just above the radio hardware which may perform radio management operations, such as to control frequencies, channelization, time synchronization, power control, beam management, channel state reporting, transmitting and receiving data over a wireless connection, and the like.

Above the PHY layer 502 may be the MAC layer 504. The MAC layer 504 may be a protocol layer which manages radio resources for communications between wireless nodes and wireless devices in some wireless networks. For example, the MAC layer 504 may serve to map between logical channels and transport channels, determine resource allocations, such as time/frequence resources, transmission scheduling, and the like.

The RLC layer 506 may be above the MAC layer 504. The RLC layer 506 may perform packetization of data for transmission, depacketization of received data, error correction, retransmission, and the like. In a disaggregated base station, the RLC layer 506 and MAC layer 504 may be implemented primarily by a DU.

The PDCP layer 508 may be above the RLC layer 506. The PDCP layer 508 may add or remove headers to incoming data for transmission or received data, respectively. The PDCP layer 508 may also perform sequencing of received data packets, encryption, and/or integrity protection for data. In a disaggregated base station, the PDCP layer 508 may be implemented primarily by a CU.

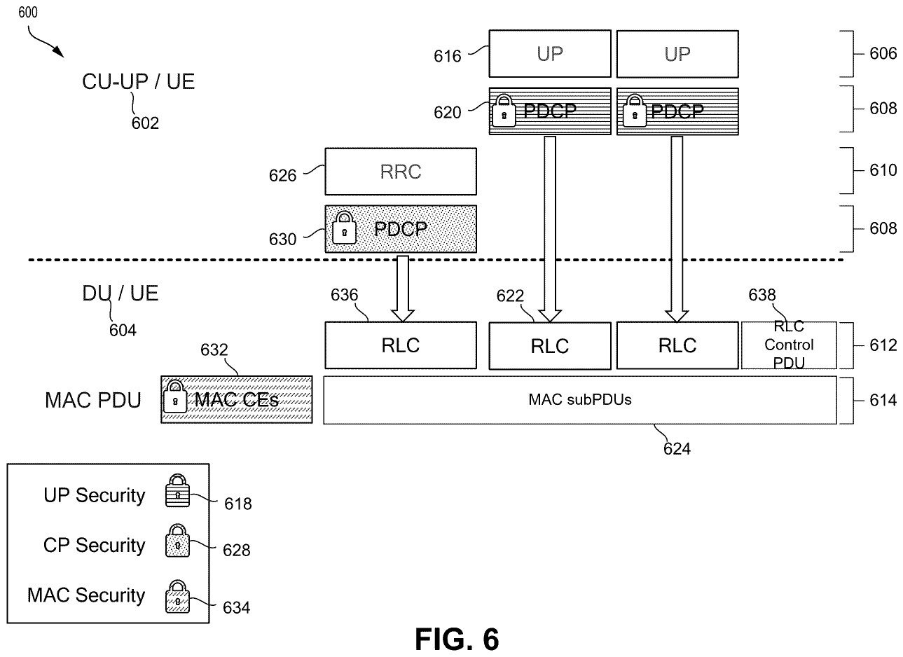

FIG. 6 is a block diagram illustrating a protocol stack 600 for packetization of data formats, in accordance with aspects of the present disclosure. FIG. 6 illustrates protocols managed by a CU 602 and DU 604. While discussed in context of wireless nodes (e.g., CU 602/DU 604), it should be understood that the techniques discussed with respect to FIG. 6 may also apply to an aggregated base station (e.g., base station that performs the functions of the CU 602 and DU 604) as well as wireless devices. For example, a wireless device may include UP, PDCP, RRC, RLC, and MAC protocol layers which may perform the techniques discussed herein in a substantially similar manner.

In some cases, the CU 602 may host a user plane (UP) 606, PDCP layer 608, and RRC layer 610 and the DU 604 may host an RLC layer 612 and MAC layer 614. In some cases, the CU 602 may obtain user plane (UP) data 616 which may be passed to a PDCP layer 608 which provides security and integrity protection. The PDCP layer 608 may apply UP security 618 and generate a PDCP data PDU 620 including the UP data 616. The PDCP data PDU 620 may be transmitted to the RLC layer 612 of the DU 604 and packaged by the RLC layer 612 into an RLC PDU 622 that may be sent to the MAC layer 614 for inclusion in a MAC subPDU 624. Similarly, the CU 602 may obtain RRC data 626 and the PDCP layer 608 may apply control plane (CP) security 628 to generate a PDCP PDU 630. The PDCP PDU 630 may also be transmitted to the RLC layer 612 of the DU 604 and packaged by the RLC layer 612 into an RLC PDU 636 that may be sent to the MAC layer 614 for inclusion in a MAC subPDU 624. In some cases, the MAC layer 614 may generate a MAC control element (CE) 632 and apply MAC security 634 to protect the MAC CE.

As indicated above, the RLC layer 612 may packetize data for transmission and primarily operates on data packets. In some cases, the RLC layer 612 may also include control information and the RLC layer 612 may generate RLC control PDUs, such as RLC control PDU 638, to carry RLC control information, such as status information for RLC PDUs at an RLC receiver indicating whether information has been received (e.g., ACK) or not received (e.g., NACK). For example, when one or more RLC PDUs have been received (e.g., by a wireless device for uplink and/or by a wireless node for downlink), the RLC layer 612 may generate an RLC control PDU 638 including an indication that the information was received. The RLC control PDU 638 may be packaged into a MAC subPDU 624 and transmitted to another device (e.g., peer device which sent the one or more RLC PDUs). A peer MAC layer of the other device may unpack the MAC subPDU and provide the RLC control PDU to a peer RLC layer. The peer RLC layer may unpack the RLC control PDU and process the indication that the information was received.

In known arrangements, the RLC layer 612 may not perform ciphering and/or integrity protection (e.g., examples of security protection that may be applied) for PDUs as security protecting PDUs may occur at the PDCP layer 608 and to some degree at the MAC layer 614. For example, the RLC layer 612 may not security protect RLC PDUs 622, 636. While data PDUs received from other layers may be security protected by those layers (e.g., via UP security 618 and/or CP security 628) RLC control signals (e.g., in RLC control PDU 638) are not protected. We have appreciated that additional control information may be added to the RLC layer 612 in the future (e.g., PDU discard information, congestion information, reassembly timer information, etc.), and, as such, it may be useful to add security protection for RLC control PDUs to help minimize potential information exposure and avoid potential fake base station attacks that may exploit RLC control PDUs.

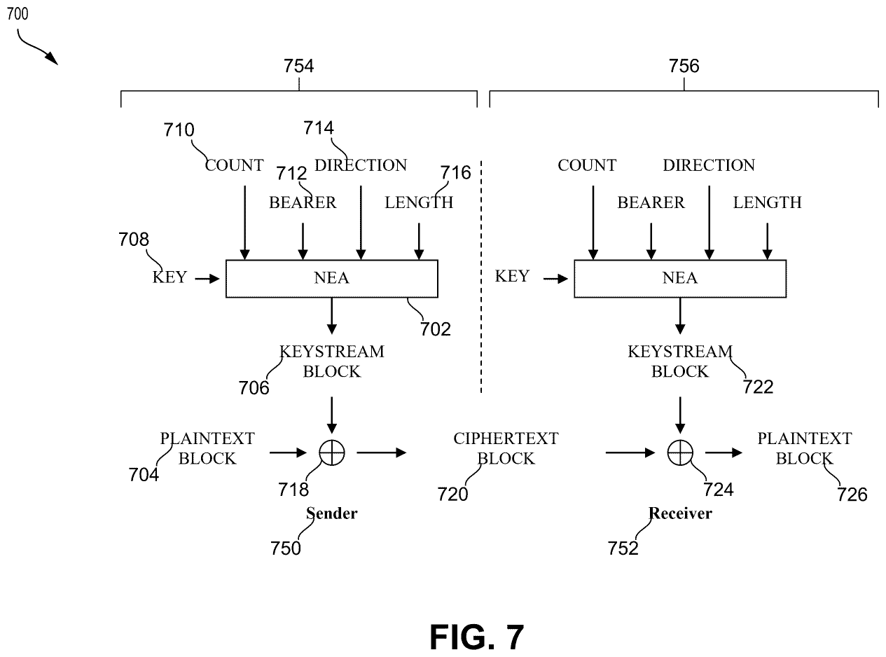

FIG. 7 illustrates RLC layer ciphering and deciphering 700, in accordance with aspects of the present disclosure. An RLC control PDU is ciphered 754 using the RLC layer ciphering by a sender 750 (e.g., transmitter) of the RLC control PDU. The ciphered RLC control PDU is then be deciphered 756 by a receiver 752 of the RLC control PDU. For example, in a wireless node with a split CU/DU (e.g., split architecture), a DU may be the sender 750 and may perform the RLC layer ciphering 754. A wireless device may be the receiver 752 and may perform the RLC layer deciphering 756. In some cases, the wireless device may also be the sender 750 of the RLC PDU and the wireless node may be the receiver 752 of the RLC PDU. The RLC layer ciphering 754 and deciphering 756 may be similar to PDCP ciphering/deciphering.

The RLC layer may perform RLC layer ciphering 754 to cipher RLC control information for an RLC control PDU for the sender 750. The RLC layer ciphering 754 may be based on an encryption algorithm, such as a NR encryption algorithm (NEA) 702. To cipher a plaintext block 704, such as data (e.g., payload) in an RLC control PDU, the NEA 702 may generate a keystream block 706 based on a set of parameters, such as a key 708, a count number 710, bearer information 712, direction 714, and length 716. In some cases, the key 708 may be, for example, an encryption key (e.g., cipher key) shared between a wireless device and a wireless node (e.g., via RRC signaling). The key 708 may be an RLC key (K_{RLC}). Of note, while discussed in the context of ciphering/deciphering an RLC control PDU, it should be understood that the techniques discussed with respect to FIG. 7 may be used to cipher any RLC PDU and are not limited to RLC control PDUs.

The count number 710 may be a sequence number or counter for the RLC control PDU being ciphered. A count number 710 may be assigned to the RLC control PDUs. In some cases, the count number 710 may be a sequentially increasing number allocated for the RLC control PDUs such that each RLC control PDU is allocated a count number that is sequentially larger than the count number allocated to a previous RLC control PDU. In some cases, the count number may be included in a header of the RLC control PDU. In some cases, the count number may be separate for RLC control PDUs (e.g., a separate RLC control PDU count number space). For example, the count number may only be incremented for RLC control PDUs. In other cases, the count number may be shared between RLC control PDUs and RLC data PDUs. For example, an RLC data PDU may include a first count number, and a following RLC data PDU may include a second count number that is sequentially larger than the first count number. In such cases, a data/control bit may be included in a header of an RLC PDU indicating whether the RLC PDU is an RLC data PDU or an RLC control PDU.

In some cases, the count number 710 may be a two-part number including a hyperframe number (HFN) and a sequence number (SN) such that [HFN, SN] where the HFN is a most significant bit of the count number 710 and the SN is the least significant bit (LSB) of the count number 710. The SN may be in x LSBs of an 8-bit count number 710 and x may be defined for a DRB via RRC configuration. In some cases, the HFN may be tracked implicitly by the sender 750 and receiver 752 and may not be included in the RLC control PDU. The SN may be included in the header of the RLC control PDU. In some cases, the SN may be incremented with each RLC control PDU (and/or RLC data PDU) and when the SN rolls over, the HFN may be incremented. In some cases, the SN and HFN may be combined to generate the count number 710.

The direction 714 may be a Boolean value indicating whether the RLC control PDU is an uplink or downlink packet. The length 716 may be based on a length (e.g., number of bits) of a payload of the RLC control PDU (e.g., length of the RLC control PDU without the unencrypted header of the RLC control PDU. The length 716 may also correspond to a number of bits of the plaintext block 704.

The bearer information 712 may be a bearer identifier number associated with the RLC control PDU. A bearer (e.g., data radio bearer (DRB)) may be a logical channel that may be used to transmit data between a wireless device and a wireless node. The bearer identifier number may be a unique number and/or alphanumeric string that identifies a specific bearer for the wireless device. The bearer identifier may be unique at least for the wireless device. In some cases, a PDCP instance or entity may be configured per bearer and PDCP operations may be handled by the CU. A PDCP instance may refer to a single logical PDCP session for a bearer and multiple, separate, PDCP sessions may exist, concurrently, such as via multi-connectivity. An RLC entity may be associated with a PDCP session and corresponding bearer. As indicated above, the RLC layer may be anchored in the DU and the DU may use a logical channel identifier (LCID) to distinguish between RLC sessions. In some cases, the DU may not have information indicating which LCID maps to which bearer identifier number and/or PDCP session. In some cases, the CU may have information indicating which LCID maps to which bearer identifier number and/or PDCP session and the CU may send the information indicating which LCID maps to which bearer identifier number and/or PDCP session to the DU, via, for example, intra-cell signaling such as an F1 interface (functional split interface).

In some cases, multiple RLC entities (e.g., connections) may exist for a given PDCP session. For example, each RLC entity may be associated with a single PDCP session and bearer, but a single PDCP session (and corresponding bearer) may be associated with multiple RLC entities. Thus, directly using the bearer identifier number for RLC layer ciphering/deciphering could result in keystream block 706 reuse (e.g., duplication of the parameters for ciphering as between two RLC entities or as between an RLC entity and the PDCP).

To avoid potential keystream block 706 reuse, a per RLC bearer information 712 may be generated. As an example, the bearer information 712 for generating the keystream block 706 may be generated based on a LCID. The LCID may be a field in the MAC message (e.g., MAC CE, MAC subPDU, etc.) that may be used to identify a logical channel (or type of MAC CE) associated with a subPDU of the MAC subPDUs. For example, the LCID may identify an RLC entity and the RLC control PDU may be associated with a particular LCID of an RLC entity that generates RLC control PDUs. In some cases, the LCID may be used as the bearer information 712.

As another example, a virtual bearer identifier may be generated for use as the bearer information 712 for generating the keystream block 706. The virtual bearer identifier may be an identifier that is based on the bearer and is different from the bearer identifier. The virtual bearer identifier may be a concatenation of the original bearer identifier number and one or more bits. As a more specific example, the original bearer identifier number may be 00000101. A virtual bearer identifier may be derived based on the original bearer identifier by concatenating a one-bit value, such as 1, to the original bearer identifier number for a virtual bearer identifier number of 100000101. The one-bit value may be predefined or the one-bit value may be based on the data/control bit. In some cases, the bit may be concatenated as the most significant bit. In some cases, the bit may be concatenated as the least significant bit. In cases of a PDCP duplication and radio link control acknowledged mode (RLC AM) deployment, multiple RLC entities may exist per bearer. In such cases, the RLC entities may use different sets of sequence numbers to avoid key reuse. As an example, one RLC entity may use even number sequence numbers, while another RLC entity may use odd number sequence numbers to avoid accidental key reuse.

In another example, a virtual LCID (e.g., eLCID) may be used as the bearer information 712 for generating the keystream block 706. The virtual LCID may be an identifier that is based on the LCID and is different from the LCID. In some cases, there is the possibility that the LCID and the bearer may be the same number, which may result in accidental keystream block 706 reuse. To avoid this, one or more bits may be concatenated with the LCID to generate the virtual LCID. As a more specific example, the original LCID may be 00000101, and a virtual LCID may be derived based on the original LCID by concatenating a one-bit value, such as 0, to the original LCID for a virtual LCID of 000000101. The one-bit value may be predefined or the one-bit value may be based on the data/control bit. In some cases, the bit may be concatenated as the most significant bit. In some cases, the bit may be concatenated as the least significant bit.

The keystream block 706 may be applied to the plaintext block 704, for example, as a bit by bit binary addition 718 of the plaintext block 704 and the keystream block 706 to generate a ciphertext block 720. The ciphertext block 720 may be a ciphered payload of the RLC control PDU. An RLC control PDU with a ciphered payload may be a ciphered RLC control PDU. The ciphered RLC control PDU may be output by the RLC layer to a MAC layer (e.g., MAC layer 614 of FIG. 6) for transmission to the receiver 752.

The receiver 752 may receive the ciphered RLC control PDU and decipher the ciphered payload of the ciphered RLC control PDU. The ciphered payload of the ciphered RLC control PDU may be input as the ciphertext block 720. Deciphering 756 the ciphertext block 720 may be performed by the RLC layer of the receiver 752. In some cases, the RLC layer of the receiver 752 may generate a keystream block 722 in a manner substantially similar to generating the keystream block 706. The keystream block 722 may be identical to keystream block 706. A bit per bit binary addition 724 of the ciphertext block 720 with the keystream block 722 may be performed to recover the plaintext block 726.

In some cases, RLC control PDU protection may be configured via RRC signaling. For example, a core network, such as core network 320 of FIG. 3 may indicate to a CU (e.g., CU 310 of FIG. 3, CU 602 of FIG. 6, etc.) to perform RLC control PDU protection. In some cases, the CU may then configure the DU to perform RLC control PDU protection. Similarly, the core network may signal, for example via RRC signaling, a wireless device to perform RLC control PDU protection. In some cases, RRC signaling may be used to initialize RLC control PDU protection. The RRC signaling may also be used to distribute key 708 for performing RLC control PDU protection. In some cases, the key 708 may be distributed to both the wireless device and the wireless node (e.g., CU/DU/eNB/gNB, etc.).

As indicated above, the CU may configure (e.g., initialize) the DU to perform RLC control PDU protection. In some cases, the CU may configure the DU to perform RLC control PDU protection based on DU security capabilities. For example, when a DU is connected to a CU, the DU may transmit an indication of the DU's security capabilities to the CU via intra-cell signaling, such as via the F1 interface. The security capabilities may include whether the DU supports RLC control PDU protection, and if so, what RLC control PDU protection techniques are supported. For example, the DU may indicate that the DU supports RLC control PDU protection. In some cases, the DU may support multiple techniques for RLC control PDU protection, such as virtual bearers and virtual LCIDs and the DU may indicate which techniques are supported by the DU. The CU may then configure the DU to perform RLC control PDU protection based on this indication, for example, via the F1 interface. For example, the DU may receive an indication to protect RLC control PDUs (e.g., to perform RLC control PDU protection). The CU and/or DU may configure the UE to perform RLC control PDU protection.

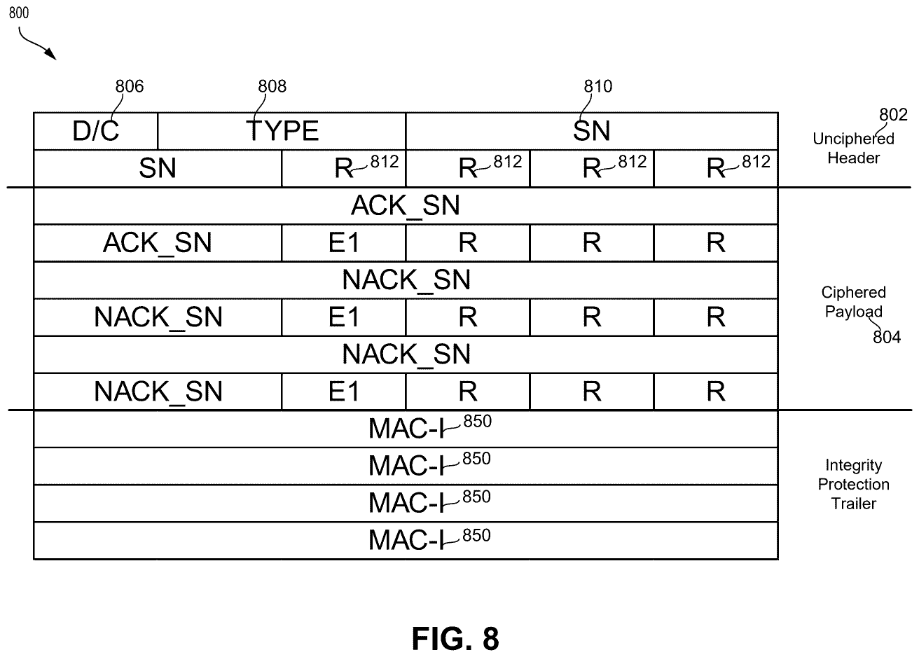

FIG. 8 is an example protected RLC control PDU 800, in accordance with aspects of the present disclosure. The protected RLC control PDU 800 may include an unciphered header 802 portion a ciphered payload 804 portion, and an integrity protection values, such as a message authentication code integrity (MAC-I) values 850. The unciphered header 802 may not be protected by the RLC layer ciphering and deciphering discussed above with respect to FIG. 7, and the ciphered payload 804 may be protected by the RLC layer ciphering and deciphering discussed above with respect to FIG. 7. In some cases, the contents of the ciphered payload 804 portion, once deciphered, may be substantially similar to a payload portion of unciphered RLC control PDUs. The contents of the ciphered payload 804 portion are not within the scope of this disclosure.

The unciphered header 802 portion of the RLC control PDU with a ciphered payload 804 portion may include a data/control bit 806, a type field 808, a count number field 810 (e.g., SN where a two-part number is used) and one or more reserved fields 812. As indicated above, the data/control bit 806 may indicate whether the RLC PDU is an RLC control PDU or an RLC data PDU. The type field 808 may indicate a type of the RLC control PDU 800. For example, there may be a set of predefined types of RLC control PDUs and the type field 808 may indicate the type of the RLC control PDU from among the predefined types. The type field 808 be substantially similar to a type field (e.g., control PDU type field) of unciphered RLC control PDUs. The count number field 810 may carry a count number of the RLC control PDU. The count number field 810 differs from an ACK_SN field or NACK_SN field as the ACK_SN field or the NACK_SN field indicate a SN/count number of an RLC data PDU (or other RLC PDU) that was received or that is missing, respectively. The one or more reserved fields 812 may be reserved for future use.

In some cases, the MAC-I values 850 may be determined on the payload of the RLC control PDU 800 before the payload is ciphered on the transmitting side. After the RLC control PDU 800 is received, candidate MAC-I values may be determined on the contents of the ciphered payload 804 portion, after deciphering, and the candidate MAC-I values may be compared to the MAC-I values 850 of the RLC control PDU 800 to verify that the payload was not altered. In some cases, the MAC-I values 850 may be determined using any integrity protection scheme, such as a MAC, checksums, etc.

As indicated above, the ciphered payload 804 may be ciphered/deciphered based on a key, such as an RLC key (K_{RLC}). In some cases, the RLC key (K_{RLC}) may be derived from a DU key (K_{DU}), which in turn is derived from an AS root key (K_{6G-RAN}).

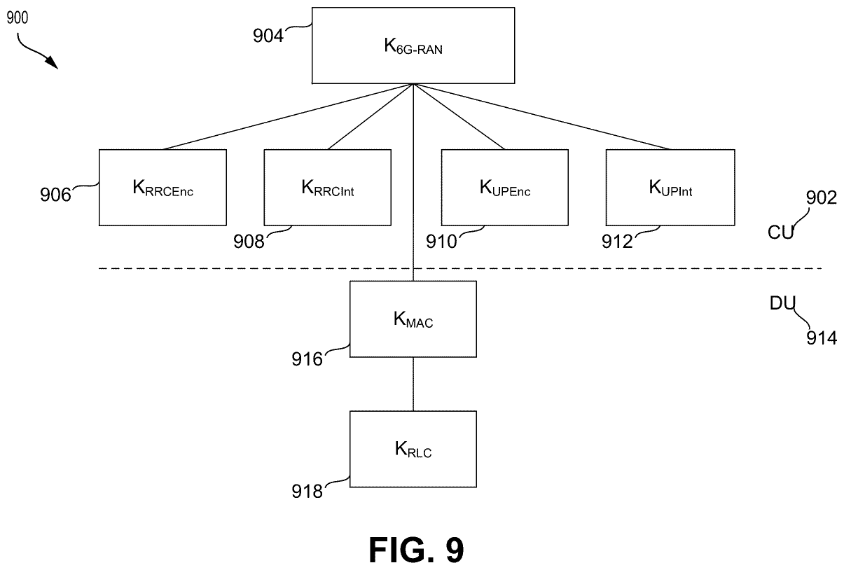

FIG. 9 is a is a tree diagram illustrating a key hierarchy 900 for a wireless system, such as wireless communications network 100, in accordance with aspects of the present disclosure. In some cases, a wireless node, such as a CU 902 (e.g., CU 310 of FIG. 3) may receive an AS root key 904 (K_{6G-RAN}) (e.g., cryptographic key) from which other keys may be derived. In some cases, the AS root key 904 may be an AS security anchor key (K_{CUA}). In some cases, the AS root key 904 may be derived from a key from a core network (e.g., core network 320 of FIG. 3), such as a security service key (K_{SecSvc}). The CU 902 may derive additional keys from the AS root key 904 for services provided by the CU 902, such as an RRC encryption key 906 (K_{RRCEnc}), RRC integrity protection key 908 (RRC_{Int}), UP encryption key 910 (K_{UPEnc}), UP integrity protection key 912 (K_{UPInt}), and the like.

The CU 902 may also derive keys for a DU 914 (e.g., DU 330 of FIG. 3). In some cases, a CU 902 may be connected to multiple DUs, and the CU 902 may derive separate sets of keys for each DU of the multiple DUs. As shown in FIG. 9, the CU 902 may derive, from the AS root key 904, a MAC key 916 (K_{MAC}) (e.g., DU key (K_{DU})) for use with the MAC layer. The MAC key 916 (K_{DU}) may be derived such that K_{DU}=KDF (K_{6G-RAN}, parameters), where the parameters may include, for example, a DU ID, physical cell identifier (PCI), frequency, cell group ID, freshness parameter and/or any DU specific parameters. The KDF may be a key derivation formula may be a cryptographic algorithm that generates one or more keys based on an input key. A DU ID may be an identifier for a particular DU. A cell group may be a grouping of wireless nodes, such as one or more DUs, with a common core network configured to perform wireless communications in a certain manner. The PCI may be a unique identifier for a cell indicated as a part of cell selection. The frequency may be a carrier frequency associated with the DU. The cell group identifier may be an identifier or number associated with a cell group. The freshness parameter may be a parameter that may be altered (e.g., refreshed) regularly to change the value generated by the KDF. For example, the freshness parameter allows the MAC key 916 (K_{MAC}/K_{DU}) to be refreshed without refreshing the AS root key 904 (K_{6G-RAN}). In some cases, a current MAC key 916 (K_{MAC}/K_{DU}) can be used as a freshness parameter to derive a new MAC key 916 (K_{MAC}/K_{DU}). In some cases, any DU specific parameters may be signaled to a wireless device, if they cannot be obtained by the wireless device via other means (e.g., SIB) so that wireless device can derive the same K_{DU}.

In some cases, in a CU-DU split architecture (e.g., as in disaggregated base station 300 of FIG. 3), the MAC layer may reside in and be managed by the DU 914. The CU 902 may transmit the MAC key 916 (K_{MAC}/K_{DU}) to the DU 914. In some cases, the DU 914 may derive additional keys based on the MAC key 916 (K_{MAC}/K_{DU}), such as an RLC key 918 (K_{RLC}). In some cases, the RLC key 918 (K_{RLC}) may be derived from the MAC key 916 (K_{MAC}/K_{DU}) such that K_{RLC}=KDF(K_{DU}, freshness parameter). The freshness parameter allows the RLC key 918 (K_{RLC}) to be refreshed (e.g., updated, changed, rederived, etc.) without having to refresh the MAC key 916 (K_{MAC}/K_{DU}), In some cases, a current RLC key 918 (K_{RLC}) can be used as a freshness parameter to derive a new RLC key 918 (K_{RLC}). In some cases, when the MAC key 916 (K_{MAC}/K_{DU}) is refreshed, the RLC key 918 (K_{RLC}) is also refreshed.

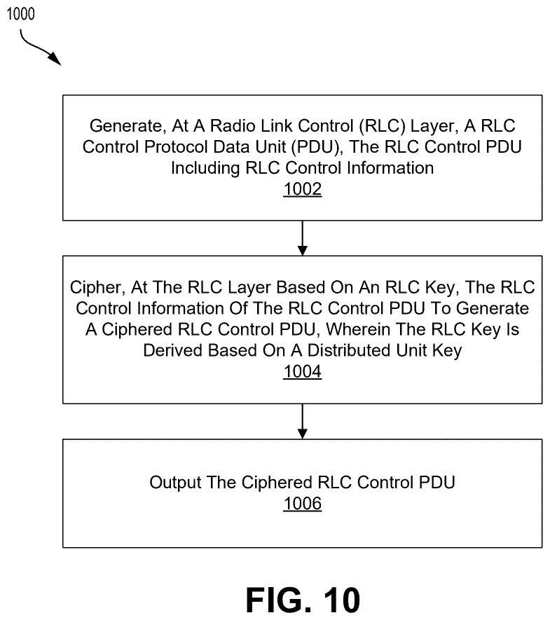

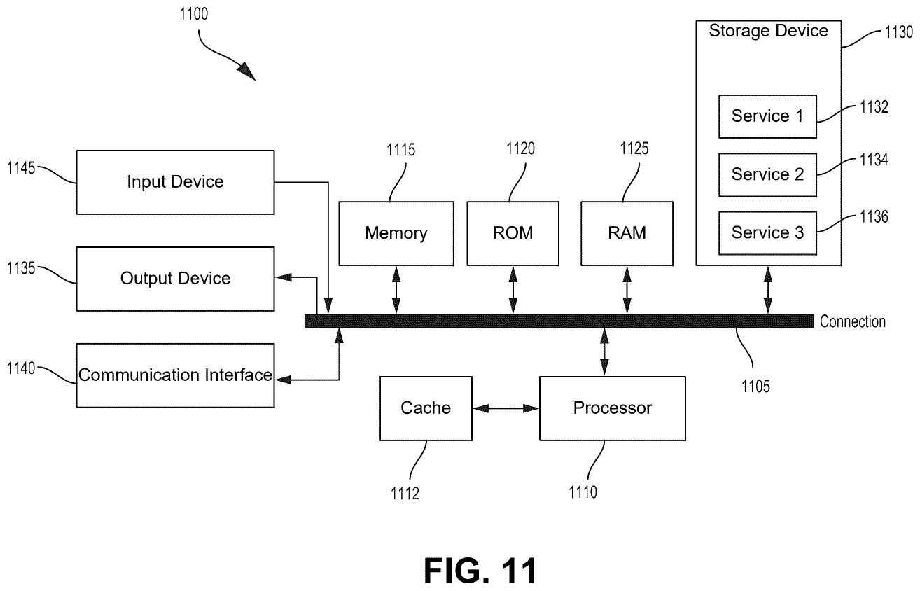

FIG. 10 is a flow diagram illustrating a process 1000 for securing communications with a wireless network, in accordance with aspects of the present disclosure. The process 1000 can be performed by a component or system (e.g., a chipset, server, device, etc.) of a wireless network (e.g., BS 102, mmW BS 180, core network 170 of FIG. 1, DU 604 of FIG. 6, computing system 1100 of FIG. 11, etc.) or a wireless device. The wireless device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device (e.g., UE 104, of FIGS. 1 and 2, respectively, wireless device 407 of FIG. 4, computing system 1100 of FIG. 11, etc.). The operations of the process 1000 may be implemented as software components that are executed and run on one or more processors (e.g., processor 1110 of FIG. 11 or other processor(s)). Further, the transmission and reception of signals by the wireless network (or component of the wireless network, such as the security service) in the process 1000 may be enabled, for example, by one or more antennas (e.g., antennas 234, 252 of FIG. 2) and/or one or more transceivers (e.g., modulators/demodulators 232, 254, TX MIMO processors 230, 266, MIMO detectors 236, 256, transmit processors 220, 254, receive processors 238, 258 of FIG. 2, etc.).

At block 1002, the computing device (or component thereof) may generate, at a radio link control (RLC) layer (e.g., RLC layer 612 of FIG. 6), an RLC control protocol data unit (PDU) (e.g., RLC control PDU 800 of FIG. 8), the RLC control PDU including RLC control information. For example, an RLC layer may be used to generate RLC control PDUs, such as RLC control PDU, to carry RLC control information, such as status information for RLC PDUs at an RLC receiver indicating whether information has been received (e.g., ACK) or not received (e.g., NACK). In some cases, the computing device (or component thereof) may transmit an indication of security capabilities of the apparatus to a wireless node; and receive an indication to protect RLC control PDUs. In some cases, the generated RLC control PDU includes a header with a control bit. In some examples, the RLC control information is ciphered based on the received indication.

At block 1004, the computing device (or component thereof) may cipher (e.g., RLC layer ciphering 754 of FIG. 7), at the RLC layer based on an RLC key (e.g., RLC key 918 of FIG. 9), the RLC control information of the RLC control PDU to generate a ciphered RLC control PDU. In some cases, the RLC key is derived based on a distributed unit key (e.g., MAC key 916 of FIG. 9). For example, the RLC layer may cipher RLC control information for an RLC control PDU for the sender. In some cases, the ciphered RLC control PDU is further ciphered based on bearer information (e.g., bearer information 712 of FIG. 7). In some examples, the bearer information is obtained based on information mapping a logical channel identifier (LCID) to a bearer identifier number received from another wireless node. The LCID may be a field in the MAC message (e.g., MAC CE, MAC subPDU, etc.) that may be used to identify a logical channel (or type of MAC CE) associated with a subPDU of the MAC subPDUs. In some cases, the bearer information comprises a virtual bearer identifier. In some examples the virtual bearer identifier comprises a concatenation of a data/control bit (e.g., data/control bit 806 of FIG. 8) with a bearer identifier number, the data/control bit indicating whether an RLC PDU is an RLC data PDU or an RLC control PDU. For examples, a virtual bearer identifier may be derived based on the original bearer identifier by concatenating a one-bit value, such the data/control bit, to the original bearer identifier number. In some cases, the bearer information comprises a logical channel identifier (LCID). In some examples, the virtual LCID comprises a concatenation of a data/control bit with a LCID, the data/control bit indicating whether an RLC PDU is an RLC data PDU or an RLC control PDU. In some cases, the ciphered RLC control PDU is ciphered based on a count number (e.g., count number field 810 of FIG. 8) of the RLC control PDU. In some examples, the count number is in sequence with a second count number of an RLC data PDU. In some cases, the count number is in sequence with a second count number of an RLC control PDU. In some examples, a header of the ciphered RLC control PDU is unciphered (e.g., unciphered header 802 of FIG. 8). In some cases, the header includes a data/control bit indicating whether an RLC PDU is an RLC data PDU or an RLC control PDU. In some examples, the computing device (or component thereof) may derive the RLC key based on the distributed unit key and a freshness parameter.

At block 1006, the computing device (or component thereof) may output the ciphered RLC control PDU. In some cases, the computing device (or component thereof) may receive a second ciphered RLC control PDU and decipher the second ciphered RLC control PDU based on a count number in a header of the second ciphered RLC control PDU. In some examples, the second ciphered RLC control PDU is further deciphered based on at least one of: a logical channel identifier (LCID); bearer information; a virtual LCID; or a virtual bearer identifier. In some cases, the computing device (or component thereof) may determine to decipher the second ciphered RLC control PDU based on a data/control bit in a header of the second ciphered RLC control PDU.

In some examples, the techniques or processes described herein may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the process 1000 and/or other processes described herein may include a processor, microprocessor, micro-computer, or other component of a device that is configured to carry out the steps of the process 1000 and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 1000 and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1000 is illustrated as a logical flow diagram, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 1000 and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 11 is a diagram illustrating an example of a system for implementing certain aspects of the present technology. In particular, FIG. 11 illustrates an example of computing system 1100, which may be for example any computing device making up internal computing system, a remote computing system, a camera, or any component thereof in which the components of the system are in communication with each other using connection 1105. Connection 1105 may be a physical connection using a bus, or a direct connection into processor 1110, such as in a chipset architecture. Connection 1105 may also be a virtual connection, networked connection, or logical connection.

In some embodiments, computing system 1100 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 1100 includes at least one processing unit (CPU or processor) 1110 and connection 1105 that communicatively couples various system components including system memory 1115, such as read-only memory (ROM) 1120 and random access memory (RAM) 1125 to processor 1110. Computing system 1100 may include a cache 1112 of high-speed memory connected directly with, in close proximity to, or integrated as part of processor 1110.

Processor 1110 may include any general purpose processor and a hardware service or software service, such as services 1132, 1134, and 1136 stored in storage device 1130, configured to control processor 1110 as well as a special-purpose processor where software instructions are incorporated into the actual processor design. Processor 1110 may essentially be a completely self-contained computing system, containing multiple cores or processors, a bus, memory controller, cache, etc. A multi-core processor may be symmetric or asymmetric.

To enable user interaction, computing system 1100 includes an input device 1145, which may represent any number of input mechanisms, such as a microphone for speech, a touch-sensitive screen for gesture or graphical input, keyboard, mouse, motion input, speech, etc. Computing system 1100 may also include output device 1135, which may be one or more of a number of output mechanisms. In some instances, multimodal systems may enable a user to provide multiple types of input/output to communicate with computing system 1100.

Computing system 1100 may include communications interface 1140, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1140 may also include one or more Global Navigation Satellite System (GNSS) receivers or transceivers that are used to determine a location of the computing system 1100 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1130 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (LA) cache, Level 5 (L5) cache, or other (L#) cache), resistive random-access memory (RRAM/ReRAM), phase change memory (PCM), spin transfer torque RAM (STT-RAM), another memory chip or cartridge, and/or a combination thereof.

The storage device 1130 may include software services, servers, services, etc., that when the code that defines such software is executed by the processor 1110, it causes the system to perform a function. In some embodiments, a hardware service that performs a particular function may include the software component stored in a computer-readable medium in connection with the necessary hardware components, such as processor 1110, connection 1105, output device 1135, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:
Aspect 1. An apparatus for securing communications for a wireless network, comprising: a memory; and a processor coupled to the memory and configured to: generate, at a radio link control (RLC) layer, an RLC control protocol data unit (PDU), the RLC control PDU including RLC control information; cipher, at the RLC layer based on an RLC key, the RLC control information of the RLC control PDU to generate a ciphered RLC control PDU, wherein the RLC key is derived based on a distributed unit key; and output the ciphered RLC control PDU.
Aspect 2. The apparatus of Aspect 1, wherein the ciphered RLC control PDU is further ciphered based on bearer information.
Aspect 3. The apparatus of Aspect 2, wherein the bearer information is obtained based on information mapping a logical channel identifier (LCID) to a bearer identifier number received from another wireless node.
Aspect 4. The apparatus of any of Aspects 2-3, wherein the bearer information comprises a virtual bearer identifier, and wherein the virtual bearer identifier comprises a concatenation of a data/control bit with a bearer identifier number, the data/control bit indicating whether an RLC PDU is an RLC data PDU or an RLC control PDU.
Aspect 5. The apparatus of any of Aspects 2-4, wherein the bearer information comprises a logical channel identifier (LCID).
Aspect 6. The apparatus of any of Aspects 2-5, wherein the bearer information comprises a virtual logical channel identifier (LCID), and wherein the virtual LCID comprises a concatenation of a data/control bit with a LCID, the data/control bit indicating whether an RLC PDU is an RLC data PDU or an RLC control PDU.
Aspect 7. The apparatus of any of Aspects 1-6, wherein the ciphered RLC control PDU is ciphered based on a count number of the RLC control PDU.
Aspect 8. The apparatus of Aspect 7, wherein the count number is in sequence with a second count number of an RLC data PDU.
Aspect 9. The apparatus of any of Aspects 1-8, wherein a header of the ciphered RLC control PDU is unciphered, and wherein the header includes a data/control bit indicating whether an RLC PDU is an RLC data PDU or an RLC control PDU.
Aspect 10. The apparatus of any of Aspects 1-9, wherein the processor is further configured to: transmit an indication of security capabilities of the apparatus to a wireless node; and receive an indication to protect RLC control PDUs, and wherein the RLC control information is ciphered based on the received indication.
Aspect 11. The apparatus of any of Aspects 1-10, wherein the processor is further configured to: receive a second ciphered RLC control PDU; and decipher the second ciphered RLC control PDU based on a count number in a header of the second ciphered RLC control PDU.
Aspect 12. The apparatus of Aspect 11, wherein the second ciphered RLC control PDU is further deciphered based on at least one of: a logical channel identifier (LCID); bearer information; a virtual LCID; or a virtual bearer identifier.
Aspect 13. The apparatus of any of Aspects 11-12, wherein the processor is further configured to determine to decipher the second ciphered RLC control PDU based on a data/control bit in a header of the second ciphered RLC control PDU.
Aspect 14. The apparatus of any of Aspects 1-13, wherein the processor is further configured to derive the RLC key based on the distributed unit key and a freshness parameter.
Aspect 15. The apparatus of any of Aspects 1-14, wherein the generated RLC control PDU includes a header with a data/control bit.
Aspect 16. A method for securing communications for a wireless network, comprising: generating, at a radio link control (RLC) layer, an RLC control protocol data unit (PDU), the RLC control PDU including RLC control information; ciphering, at the RLC layer based on an RLC key, the RLC control information of the RLC control PDU to generate a ciphered RLC control PDU, wherein the RLC key is derived based on a distributed unit key; and outputting the ciphered RLC control PDU.
Aspect 17. The method of Aspect 16, wherein the ciphered RLC control PDU is further ciphered based on bearer information.
Aspect 18. The method of Aspect 17, wherein the bearer information is obtained based on information mapping a logical channel identifier (LCID) to a bearer identifier number received from another wireless node.
Aspect 19. The method of any of Aspects 17-18, wherein the bearer information comprises a virtual bearer identifier, and wherein the virtual bearer identifier comprises a concatenation of a data/control bit with a bearer identifier number, the data/control bit indicating whether an RLC PDU is an RLC data PDU or an RLC control PDU.
Aspect 20. The method of any of Aspects 17-19, wherein the bearer information comprises a logical channel identifier (LCID).
Aspect 21. The method of any of Aspects 17-20, wherein the bearer information comprises a virtual logical channel identifier (LCID), and wherein the virtual LCID comprises a concatenation of a data/control bit with a LCID, the data/control bit indicating whether an RLC PDU is an RLC data PDU or an RLC control PDU.
Aspect 22. The method of any of Aspects 16-21, wherein the ciphered RLC control PDU is ciphered based on a count number of the RLC control PDU.
Aspect 23. The method of Aspect 22, wherein the count number is in sequence with a second count number of an RLC data PDU.
Aspect 24. The method of any of Aspects 16-23, wherein a header of the ciphered RLC control PDU is unciphered, and wherein the header includes a data/control bit indicating whether an RLC PDU is an RLC data PDU or an RLC control PDU.
Aspect 25. The method of any of Aspects 16-24, further comprising: transmitting an indication of security capabilities of a wireless device to a wireless node; and receiving an indication to protect RLC control PDUs, and wherein the RLC control information is ciphered based on the received indication.
Aspect 26. The method of any of Aspects 16-25, further comprising: receiving a second ciphered RLC control PDU; and deciphering the second ciphered RLC control PDU based on a count number in a header of the second ciphered RLC control PDU.
Aspect 27. The method of Aspect 26, wherein the second ciphered RLC control PDU is further deciphered based on at least one of: a logical channel identifier (LCID); bearer information; a virtual LCID; or a virtual bearer identifier.
Aspect 28. The method of any of Aspects 26-27, further comprising determining to decipher the second ciphered RLC control PDU based on a data/control bit in a header of the second ciphered RLC control PDU.
Aspect 29. The method of any of Aspects 16-28, further comprising deriving the RLC key based on the distributed unit key and a freshness parameter.
Aspect 30. The method of any of Aspects 16-29, wherein the generated RLC control PDU includes a header with a data/control bit.
Aspect 31. A non-transitory computer-readable medium having stored thereon instructions that, when executed by at least one processor, cause the at least one processor to perform operations according to any of Aspects 16-30.
Aspect 32. An apparatus for securing communications for a wireless network comprising one or more means for performing operations according to any of Aspects 16-30.
Aspect 33. The apparatus of Aspect 4, wherein the virtual bearer identifier comprises an identifier that is based on the bearer and is different from the bearer identifier.
Aspect 34. The method of Aspect 19, wherein the virtual bearer identifier comprises an identifier that is based on the bearer and is different from the bearer identifier.
Aspect 35. The apparatus of Aspect 6, wherein the virtual LCID comprises an identifier that is based on the LCID and is different from the LCID.
Aspect 36. The method of Aspect 21, wherein the virtual LCID comprises an identifier that is based on the LCID and is different from the LCID.

What is claimed is:

1. An apparatus for securing communications for a wireless network, comprising:
a memory; and
a processor coupled to the memory and configured to:
generate, at a radio link control (RLC) layer, an RLC control protocol data unit (PDU), the RLC control PDU including RLC control information;
cipher, at the RLC layer based on an RLC key, the RLC control information of the RLC control PDU to generate a ciphered RLC control PDU, wherein the RLC key is derived based on a distributed unit key; and
output the ciphered RLC control PDU.

2. The apparatus of claim 1, wherein the ciphered RLC control PDU is further ciphered based on bearer information.

3. The apparatus of claim 2, wherein the bearer information is obtained based on information mapping a logical channel identifier (LCID) to a bearer identifier number received from another wireless node.

4. The apparatus of claim 2, wherein the bearer information comprises a virtual bearer identifier, and wherein the virtual bearer identifier comprises a concatenation of a data/control bit with a bearer identifier number, the data/control bit indicating whether an RLC PDU is an RLC data PDU or an RLC control PDU.

5. The apparatus of claim 2, wherein the bearer information comprises a logical channel identifier (LCID).

6. The apparatus of claim 2, wherein the bearer information comprises a virtual logical channel identifier (LCID), and wherein the virtual LCID comprises a concatenation of a data/control bit with a LCID, the data/control bit indicating whether an RLC PDU is an RLC data PDU or an RLC control PDU.

7. The apparatus of claim 1, wherein the ciphered RLC control PDU is ciphered based on a count number of the RLC control PDU.

8. The apparatus of claim 7, wherein the count number is in sequence with a second count number of an RLC data PDU.

9. The apparatus of claim 1, wherein a header of the ciphered RLC control PDU is unciphered, and wherein the header includes a data/control bit indicating whether an RLC PDU is an RLC data PDU or an RLC control PDU.

10. The apparatus of claim 1, wherein the processor is further configured to:
transmit an indication of security capabilities of the apparatus to a wireless node; and
receive an indication to protect RLC control PDUs, and wherein the RLC control information is ciphered based on the received indication.

11. The apparatus of claim 1, wherein the processor is further configured to:
receive a second ciphered RLC control PDU; and
decipher the second ciphered RLC control PDU based on a count number in a header of the second ciphered RLC control PDU.

12. The apparatus of claim 11, wherein the second ciphered RLC control PDU is further deciphered based on at least one of:
a logical channel identifier (LCID);
bearer information;
a virtual LCID; or
a virtual bearer identifier.

13. The apparatus of claim 11, wherein the processor is further configured to determine to decipher the second ciphered RLC control PDU based on a data/control bit in a header of the second ciphered RLC control PDU.

14. The apparatus of claim 1, wherein the processor is further configured to derive the RLC key based on the distributed unit key and a freshness parameter.

15. The apparatus of claim 1, wherein the generated RLC control PDU includes a header with a data/control bit.

16. A method for securing communications for a wireless network, comprising:
generating, at a radio link control (RLC) layer, an RLC control protocol data unit (PDU), the RLC control PDU including RLC control information;
ciphering, at the RLC layer based on an RLC key, the RLC control information of the RLC control PDU to generate a ciphered RLC control PDU, wherein the RLC key is derived based on a distributed unit key; and
outputting the ciphered RLC control PDU.

17. The method of claim 16, wherein the ciphered RLC control PDU is further ciphered based on bearer information.

18. The method of claim 17, wherein the bearer information is obtained based on information mapping a logical channel identifier (LCID) to a bearer identifier number received from another wireless node.

19. The method of claim 17, wherein the bearer information comprises a virtual bearer identifier, and wherein the virtual bearer identifier comprises a concatenation of a data/control bit with a bearer identifier number, the data/control bit indicating whether an RLC PDU is an RLC data PDU or an RLC control PDU.

20. The method of claim 17, wherein the bearer information comprises a logical channel identifier (LCID).

21. The method of claim 17, wherein the bearer information comprises a virtual logical channel identifier (LCID), and wherein the virtual LCID comprises a concatenation of a data/control bit with a LCID, the data/control bit indicating whether an RLC PDU is an RLC data PDU or an RLC control PDU.

22. The method of claim 16, wherein the ciphered RLC control PDU is ciphered based on a count number of the RLC control PDU.

23. The method of claim 22, wherein the count number is in sequence with a second count number of an RLC data PDU.

24. The method of claim 16, wherein a header of the ciphered RLC control PDU is unciphered, and wherein the header includes a data/control bit indicating whether an RLC PDU is an RLC data PDU or an RLC control PDU.

25. The method of claim 16, further comprising:
transmitting an indication of security capabilities of a wireless device to a wireless node; and
receiving an indication to protect RLC control PDUs, and wherein the RLC control information is ciphered based on the received indication.

26. The method of claim 16, further comprising:
receiving a second ciphered RLC control PDU; and
deciphering the second ciphered RLC control PDU based on a count number in a header of the second ciphered RLC control PDU.

27. The method of claim 26, wherein the second ciphered RLC control PDU is further deciphered based on at least one of:
a logical channel identifier (LCID);
bearer information;
a virtual LCID; or
a virtual bearer identifier.

28. The method of claim 26, further comprising determining to decipher the second ciphered RLC control PDU based on a data/control bit in a header of the second ciphered RLC control PDU.

29. The method of claim 16, further comprising deriving the RLC key based on the distributed unit key and a freshness parameter.

30. The method of claim 16, wherein the generated RLC control PDU includes a header with a data/control bit.
